(19) United States
(12) Patent Application Publication
(10) Pub. No.: US 2019/0383581 A1
(43) Pub. Date: Dec. 19, 2019

(54) Device and Method for Registering a Hit on a Target

(71) Applicant: QINETIQ LIMITED, Farnborough, Hampshire (GB)

(72) Inventors: Ian Ralph Caesar, Salisbury, Wiltshire (GB); Simon Thomas Parker, Bentley, Hampshire (GB); John Patrick Kelly, Welling, Greater London (GB)

(21) Appl. No.: 16/485,316

(22) PCT Filed: Feb. 12, 2018
(86) PCT No.: PCT/EP2018/053383

§ 371 Date: Aug. 12, 2019

(30) Foreign Application Priority Data
Feb. 15, 2017 (GB) 1702439.9

(51) Int. Cl. F41G 3/26; G09B 9/00

(52) U.S. Cl. CPC F41G 3/265; G09B 9/003; F41G 3/2688

(57) ABSTRACT

The invention relates to a device, system and method for registering a hit on a target and in particular to an improved device, system and method for registering the hit quickly to reduce feedback delay time. A device according to an embodiment comprises: a position storage unit for storing a known position of at least one target; a positioning unit comprising a laser range finder for aiming a weapon or weapon simulator at a weapon aim position; a determining unit for determining whether, when engaging the target, the weapon aim position and the stored position match; and a hit registering unit for registering, based on the determination,

The invention relates to a device, system, method and program for registering a hit on a target and in particular to an improved device, system, method and program for registering the hit quickly to reduce feedback delay time.

In modern warfare simulations (real training environments in which military tactics can be carried out), such as warfare-style environments in which training exercises are carried out, a number of challenges are faced in ensuring that useful data is extracted from the training exercises and that the data is collected in an efficient manner.

In warfare simulations and actual warfare, target hand-off systems (systems for acquiring a target and relaying the location of that target to a shooter or marksman) may be slow and involve a largely manual process. For example one or more targets are detected by sensors (including being manually detected by personnel). The location of the detected targets is then transferred by voice using grids (grid mapping systems), or as points on a map using an electronic GIS (geographic information system). These targets often then undergo a mensuration process, prior to being passed onto the shooter. At the shooter end the location of the target is then generally manually converted into a range and bearing from the position of the engaging weapon, to enable engagement with the target.

Alternative target hand-off systems are automated, expensive and bulky. For example, in this system a target is detected by precision sensors. The target is then passed directly into an automatic weapons system for engagement. This process requires the initial target detection to be of high accuracy as well as requiring highly accurate sensors and controllers of the weapons system. To achieve this level of accuracy, precision components are required which are often of too great a size and weight to be practicable, and generally too expensive to be widely affordable.

In addition, when multiple targets are received from multiple sources, the information relating to these targets needs to be reviewed and managed, with the subsequent engagements suitably de-conflicted (duplicates removed).

In a training exercise, to avoid using live ammunition and risk injury to the participants to the exercise one possibility is to use sensors attached to each of the targets to register when a target is hit. Such sensor can however be expensive and require a direct line-of sight between the shooter and the sensor, which may be affected by smoke or heavy fog for example.

The invention is intended to solve or mitigate problems associated with the related systems.

According to an embodiment of an aspect there is provided a device (hit registering device) for registering a hit on a target, the device comprising: a position storage unit for storing a known position of at least one target; a positioning unit comprising a laser range finder for aiming a weapon or weapon simulator at a weapon aim position; a determining unit for determining whether, when engaging the target, the weapon aim position and the stored position match; and a hit registering unit for registering, based on the determination, a hit on the target.

The device provides a more efficient way of registering a hit on a target with the hit registration being able to be determined quickly based on information stored in the device, without the need to wait for feedback from the target in the form of a hit confirmation signal or to verify the hit by visual confirmation.

The position storage unit is able to store known positions of one or more targets. In the case of multiple targets, the position storage unit stores the position (location) of each of the targets.

A weapon or weapon simulator is deemed to be engaging a target when either a projectile or other form of ammunition is fired at the target, or, if a weapon simulator uses a laser or other device to simulate weapons' fire, when a trigger simulating the shooting (firing) of the weapon is activated (e.g. by being pressed or squeezed). Firing at the target may be any time from when the weapon is fired until when the simulated projectile would be expected to hit the target. It is to be understood that reference herein to a “weapon” includes a weapon simulator which may fire blank ammunition or may represent the behaviour of a weapon for the purpose of the warfare simulation.

In determining whether the weapon is pointed (aimed) at any one of the targets, the weapon is deemed to be pointed at the target if it is pointed at any part of the target. Therefore, the weapon aim position and the stored position are considered to match within a margin for error. The margin for error preferably takes into account the size of the target, such that even if the weapon aim position varies slightly from the stored position, but the target would still be hit, the positions are deemed to match. Further, position information may be presented in different formats. However, even when presented in different formats, the weapon aim position and the stored position are considered to match when the positions are geographically the same, within the margin for error.

If the determining unit determines that, when firing at/engaging the target, the weapon is pointed at the target, the hit registering unit registers a hit on the target. If the determining unit determines that, when firing at the target, the weapon is not pointed at the target, the hit registering unit does not register a hit on the target or registers a miss.

The laser range finder can provide improved accuracy of the distance between the determining unit and the target. Optionally, the laser range finder may be attached to the weapon, or be at substantially the same distance from the target to simplify distance calculations. However, this is not essential as the difference in the two distances may be taken into account during subsequent analysis of the data produced.

A laser range finder can also be used to aim at/detect objects which are not targets. For example, if the positioning unit is aimed at an object at a position other than the known positions of the targets, this may be determined to be a non-target object. During the warfare simulation exercises, it is advantageous to collect data from the exercise and compare the position aimed at by the laser range finder and the known position stored in the position storage unit to provide useful and concise feedback to the shooter so that unintentional shots being fired at non-target objects can be avoided.

Further, a laser range finder also provides a more accurate determination of whether the weapon is, at the time of firing, pointed at the target, as the range of the weapon and the distance to the target are linked to the accuracy of the shot. For example, if a target is out of range of a particular weapon, it would not matter if the weapon is aimed towards the target or not, no hit could be registered. The accuracy of the hit registration depends on the standards required for the exercise. Therefore, it may be that whether a weapon could actually hit a target or not is irrelevant if for example the shooter is instead learning to use the aiming system and the operation thereof. In this case the laser range finder is pointed in the desired direction to define the weapon aim position and that direction is used to determine whether the target is hit or not. The weapon range may then be taken into account subsequently once the shooter is sufficiently proficient with the weapon.

Optionally, according to an embodiment, the device further comprises a rotary encoder attached to the laser range finder, for setting a direction of the laser range finder.

An advantage associated with using a rotary encoder is a greater level of accuracy in the positioning of the laser range finder, and thereby the positioning of the weapon or weapon simulator can also be improved. The laser range finder may for example be mounted on a rotating platform which is positioned by the rotary encoder.

Optionally, according to an embodiment, the device further comprises a damage estimation unit (damage estimator) for estimating damage to the target based on distance to the target and/or location of the hit on the target.

The damage estimation unit takes into account the distance between the weapon or weapon simulator and the target and/or where on the target the ammunition/laser beam would have hit. The estimation of damage to a target may be based on a prediction of where the projectile is expected to hit the target as some areas may be more vulnerable than others, and how far the projectile has travelled before hitting the target which may indicate whether the projectile has slowed at all before impact. More detailed damage estimation may take into account information on the target, such as the type of vehicle/vessel, size, potential weak points or conversely potentially reinforced parts. Further factors included in damage estimation may be the type of weapon or simulated weapon fired.

Optionally, according to an embodiment, the device further comprises a target identification storage unit (target identification storage) for storing identification information of the target.

The identifying information may be stored in a storage unit in the system to aid efficient reference to this information for faster feedback to the shooter. Identification information may include an identifier for each target, characteristic information of the target such as type of vehicle (in the case of military ships for example a frigate, destroyer, aircraft carrier, etc.), size, defences and weapons (armament).

Optionally, according to an embodiment, when the determining unit determines that, when engaging the target, the weapon was not pointed at a target, the determining unit is configured to determine whether the weapon was pointed at an object other than a target.

While the accuracy of a shooter is important to ensure a target is hit, it is also important to avoid firing at other objects. Such objects may include other friendly vehicles, civilian vehicles, or other non-military vehicles.

Optionally, according to an embodiment, the known position of the at least one target stored in the position storage unit is based on a global positioning system (GPS) signal received from the at least one target.

In order to provide the position storage unit with accurate position information on the targets, a GPS signal may be transmitted from each target to the position storage unit for later comparison with the weapon aim positions. Additionally, the weapon may also use GPS to give an exact position thereof. Specifically, the weapon may output a GPS signal indicating its own location for example to the determining unit.

According to an embodiment of another aspect, there is provided a system comprising: the device described above; and a GPS transmitter for transmitting a GPS signal indicating the position of the target.

According to an embodiment of another aspect, there is provided a method and a program for registering a hit on a target, according to any of the appended method or program claims.

The invention will now be described, by way of example only, with reference to the following drawings, in which:

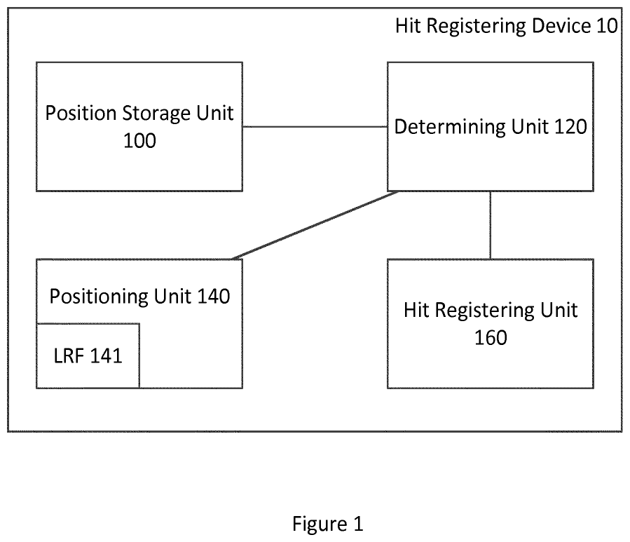

FIG. 1 shows a hit registering device according to an embodiment;

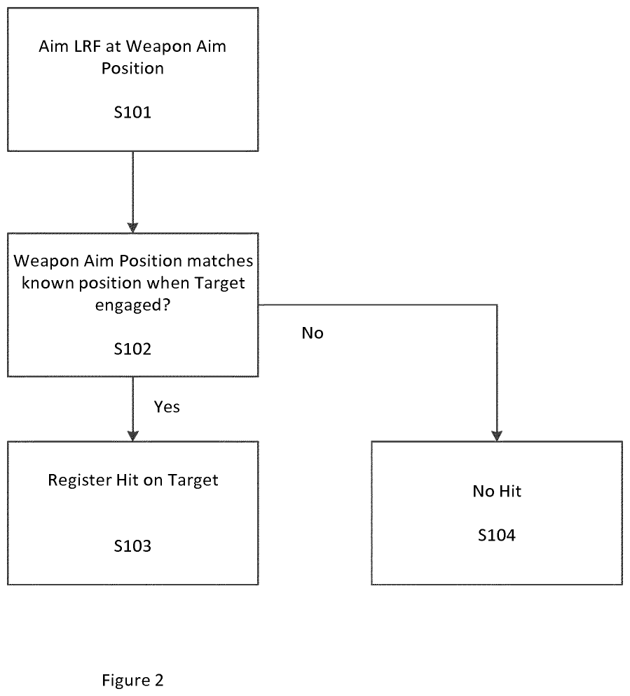

FIG. 2 shows a flow chart showing a method for registering a hit according to an embodiment;

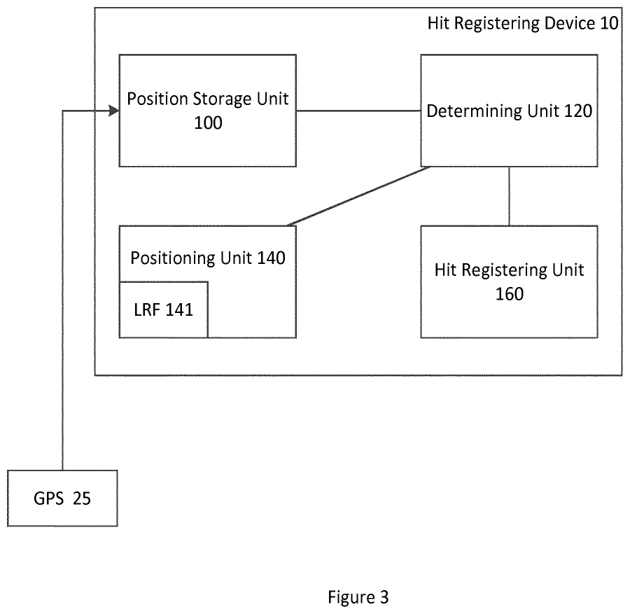

FIG. 3 shows a system according to an embodiment;

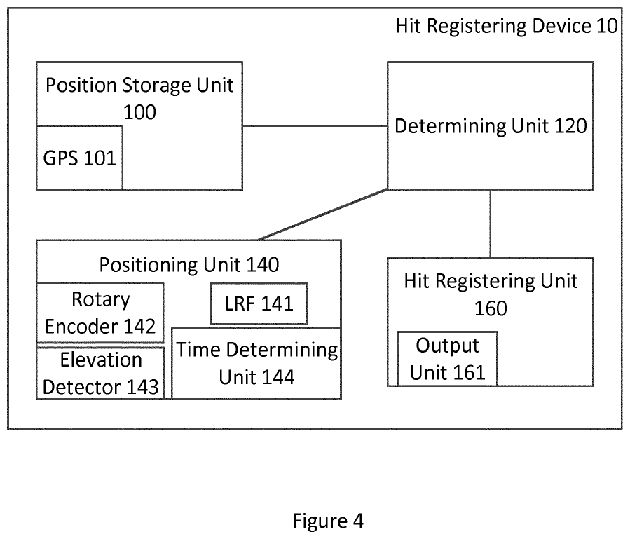

FIG. 4 is shows a hit registering device according to another embodiment; and

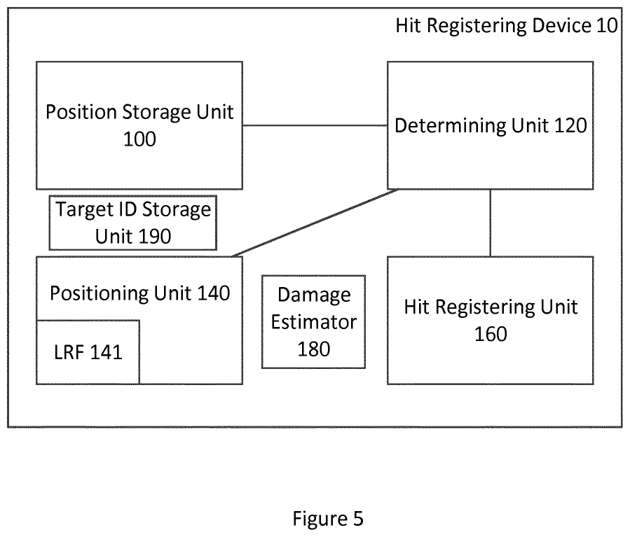

FIG. 5 is shows a hit registering device according to still another embodiment.

The invention relates to improvements for systems used in a warfare simulation or other training environments to ensure accuracy of the exercise and provide suitable feedback to the personnel involved.

In such a training environment, there are typically two or more opposing “sides”, wherein each side will attempt to fire their available weapons at the members (or vehicles) of the other side, the “targets”. The invention provides a device which allows a participant in the wargames, which may for example be a person firing a weapon, a “shooter”, or an observer, to obtain clear and concise information about the performance of each of the participants in the exercise, the shooters. In particular, it can be efficiently assessed whether a shooter achieves a “hit” on a particular target. A hit is an accurate shot/firing of a weapon or weapon simulator on a target. More specifically, a hit is when the weapon or weapon simulator is aimed and positioned such that the weapon, if fired, would hit the target. In the training environment, weapons may be weapon simulators, for example which behave in a similar manner to real weapons, but do not fire live ammunition or other projectiles. Weapon simulators include a ‘trigger’ to determine when the shooter fires the weapon simulator.

According to an embodiment there is provided a device 10 for registering a hit on a target. The device 10 includes a position storage unit (a position storage) 100, a positioning unit (a positioner) 140, a determining unit (a determiner) 120 and a hit registering unit (a hit register) 160. The positioning unit 140 includes a laser range finder 141. This embodiment is shown for example in FIG. 1. A further embodiment including a GPS transmitter 25, as shown in FIG. 3, for transmitting a position of a target. The GPS transmitter 25 may be included in a target 20 or may be separate from the target 20. A second GPS transmitter (not shown) may be included in the weapon or laser range finder 141 for transmitting the location of the weapon or laser range finder, respectively.

The position storage unit 100 stores position(s) of at least one (one or more) targets 20. These positions are therefore known positions. The position storage unit 100 may for example have the positions of the targets 20 stored before an exercise is commenced if the targets 20 are not expected to move during the exercise or may receive updates periodically of the positions, if the targets 20 move. The position storage unit 100 may include a radar receiver or a global positioning system (GPS) signal receiver 101. The GPS signal receiver 101 may receive a signal transmitted from a target 20 including information indicating its position.

The positioning unit 140 includes a laser range finder (LRF) 141 which aims a weapon or weapon simulator at a weapon aim position and which may be used to detect the distance between the LRF 141 and whatever it is aimed at, for example a target 20. The use of an LRF 141 increases the distance measurement accuracy to the target 20 and makes it possible to more reliably determine whether a target 20 is out of range or not. The positioning unit 140 is operated by the shooter and may be aimed manually using line of sight or with the assistance of a targeting means.

The determining unit 120 determines whether, at a time a weapon is fired, the weapon was pointed at a target 20 of the one or more targets 20. The determining unit 120 determines this by comparing the known position of the target 20 with the weapon aim position. If the determining unit 120 determines that, when firing at the target 20, the weapon is pointed at the target 20, the hit registering unit 160 registers a hit on the target 20. If the determining unit 120 determines that, when firing at the target 20, the weapon is not pointed at the target 20, the hit registering unit 160 does not register a hit on the target 20.

Based on the determination by the determining unit 120, the hit registering unit 160 either registers a hit or not. The hit registering unit 160 may optionally have an output unit 161 for outputting whether a hit is registered or not. The output unit 161 may for example be a display or speaker.

The LRF 141 may be attached to a rotary encoder 142 detecting an angle of rotation of the LRF 141, an elevation detector 143 detecting the angle of elevation of the LRF 141 and/or a time determining unit 144 for determining the time at which the weapon is fired. Using a rotary encoder 142 for example allows the LRF 141 to be mounted on a rotating platform wherein the rotary encoder 142 moves the rotating platform to the desired position. An elevation detector 143 provides greater accuracy when firing slower moving projectiles, which will travel along a parabolic path to the target 20. A time determining unit 144 may for example be a clock or a timer, which is programmed as a general purpose clock giving actual local time as a reference or as a timer showing how long since the exercise began it took to hit the target. FIG. 4 shows an exemplary embodiment including these features.

In an embodiment, the device 10 includes the weapon to be fired (not shown in the figures). Alternatively, the weapon may be separate from the device 10.

Thus, according to an embodiment, the invention includes an improved warfare simulation whereby a “hit” (an accurate shot on target) is registered upon receipt of a signal originating from a weapon indicating that it was aimed at a target and subsequently fired. This is in contrast to a system whereby a hit is registered upon receipt of a signal generated by the target itself when a sensor mounted on the target detects that a weapon was aimed at it and fired.

Following one or more hits, when the ‘damage’ reaches a certain level the target can be told to stop taking part in the warfare simulation via a radio link. The ‘damage’ can be modified depending on the training scenario and, as the range to the target is known, the ‘damage’ can be proportional to how far away the target is depending on the weapon's maximum effective range. In a device or system having multiple weapons, when a hit is registered, it is determined by the hit registering unit 160 which weapon was fired.

There is further provided a method for registering a hit on a target. The method comprises a step of aiming, by a laser range finder, a weapon or weapon simulator at a weapon aim position S101. The method further involves determining whether, when engaging a target, the weapon aim position matches a known position of the target S102, and finally registering, based on the determination, a hit on the target S103 and S104. FIG. 2 shows a flowchart including the steps of this method.

FIG. 5 shows a further embodiment including a damage estimator 180 which estimates damage to the target based on distance to the target and/or location of the hit on the target. The device 10 may further include a target identification storage unit 190 which stores identification information of the targets 20.

1. A device for registering a hit on a target, the device comprising:
a position storage unit for storing a known position of at least one target;
a positioning unit comprising a laser range finder for aiming a weapon or weapon simulator at a weapon aim position;
a determining unit for determining whether, when engaging the target, the weapon aim position and the stored position match; and
a hit registering unit for registering, based on the determination, a hit on the target.

2. The device according to claim 1, further comprising:
a rotary encoder attached to the laser range finder, for setting a direction of the laser range finder.

3. The device according to claim 1, further comprising:
a damage estimation unit for estimating damage to the target based on distance to the target and/or location of the hit on the target.

4. The device according to claim 1, further comprising:
a target identification storage unit for storing identification information of the target.

5. The device according to claim 1, wherein
when the determining unit determines that, when engaging the target, the weapon was not pointed at a target, the determining unit is configured to determine whether the weapon was pointed at an object other than a target.

6. The device according to claim 1, wherein
the known position of the at least one target stored in the position storage unit is based on a global positioning system (GPS) signal received from the at least one target.

7. A system comprising:
the device according to claim 1; and
a GPS transmitter for transmitting a GPS signal indicating the position of the target.

8. A method for registering a hit on a target, the method comprising:
aiming, by a laser range finder, a weapon or weapon simulator at a weapon aim position;
determining whether, when engaging a target, the weapon aim position matches a known position of the target; and
registering, based on the determination, a hit on the target.

9. The method according to claim 8, further comprising:
setting a direction of the laser range finder by a rotary encoder attached to the laser range finder.

10. The method according to claim 8, further comprising:
estimating damage to the target based on distance to the target and/or location of the hit on the target.

11. The method according to claim 8, further comprising:
storing identification information of the target in a target identification storage unit.

12. The method according to claim 8, further comprising:
when it is determined that, when engaging the target, the weapon was not pointed at a target, further determining whether the weapon was pointed at an object other than a target.

13. The method according to claim 8, wherein
the known position of the one or more targets stored in the position storage unit is based on a global positioning system (GPS) signal received from the one or more targets.

14. A program which, when executed on a computer, causes the computer to execute a process including the method according to of claim 8.
